(19) United States
(12) Patent Application Publication
(10) Pub. No.: US 2009/0210945 A1
(43) Pub. Date: Aug. 20, 2009

(54) Personal Information/Confidential Information Managing System And Personal Information/Confidential Information Managing Method

(76) Inventor: Hisao Kato, Tokyo (JP)

Correspondence Address: BUCHANAN, INGERSOLL & ROONEY PC, POST OFFICE BOX 1404, ALEXANDRIA, VA, 22313-1404, US

(21) Appl. No.: 12/304,516

(22) PCT Filed: Jun. 25, 2007
(86) PCT No.: PCT/JP07/62667

§ 371 Date: Dec. 12, 2008

(30) Foreign Application Priority Data
Jun. 26, 2006 (JP) 2006-175416

(51) Int. Cl. G06F 21/24; G06F 12/00; G09C 1/00

(52) U.S. Cl. 726/26

(57) ABSTRACT

A personal information/confidential information managing system and a personal information/confidential information managing method are provided for managing personal information/confidential information in a proper form in accordance with a variable protective level subjected to change of protective levels to comply with necessity of secrecy management in keeping personal information/confidential information in the custody. A personal information/confidential information managing device keeps personal information/confidential information in the custody with a different state for every protective level in accordance with protective levels set in compliance with the degree of confidentiality of the personal information/confidential information. Although this protective level is described in a data property definition file and is read in a computer program, it can be changed appropriately. A protective level after the change and its changing time to be designated are described in the data property definition file, so that the computer program installed in the personal information/confidential information managing device changes a keeping form of the personal information/confidential information in compliance with the protective level after the change when the changing time arrives.

### TECHNICAL FIELD

The present invention relates to a personal information/confidential information management system and a personal information/confidential information management method for managing personal information/confidential information in appropriate mode depending on a variable protection level, which is changed when needed according to necessity of security protection at the time of storing personal information/confidential information.

### BACKGROUND ART

At the time of storing personal information/confidential information, it is required to sufficiently pay attention to security protection. Various methods for security protection are devised. For example, in a method disclosed in Japanese Unexamined Patent Application Laid-Open No. 2004-145755, in the case of storing important confidential data, the original data is not simply encrypted but is subjected to secret sharing scheme and the resultant data is stored whereby the data can be reconstructed without central management.

The applicant of the present invention also has proposed a technique of storing information while paying full attention to security protection in Japanese Patent Application No. 2004-381710.

### Patent Document 1: Japanese Patent Application Laid-Open No. 2004-145755

### DISCLOSURE OF THE INVENTION

### Problems to be Solved by the Invention

The conventional techniques are directed to store confidential information, personal information, and data of confidential information while paying full attention to security protection.

Here, even for the same information, necessity of protection is not always the same. For example, in many cases, designs and the like are kept confidential until a new product is released thereby preventing other companies to outflank. However, once a new product is released, it is unnecessary to keep them confidential. On the contrary, there is a case that disclosed information has to be concealed. For example, a telephone number listed in a telephone book is cancelled due to various sales calls.

That is, the degree of confidentiality for identical information may be varied with lapse of time and according to various situations. It is desirable to store information in a mode according to the degree of secrecy. Information initially stored in plain text should not remain in plain text when the information is required to be kept in confidential. On the other hand, information initially kept in confidential does not need to remain encrypted and may be decrypted to plain text when the information can be disclosed in public. It is rather preferable to store such information in plain text in order to access the information easily. This is because information in plain text can be more promptly referred to and searched. However, such a point is not considered in the conventional inventions.

Therefore, in view of the problems, an object of the present invention is to provide a mechanism of storing and managing subject information most appropriately for a circumstance at that time point.

### Means for Solving the Problems

To achieve the object, the present invention has the following configurations.

A personal information/confidential information management system according to a claim 1 is a personal information/confidential information management system for storing personal information/confidential information paying attention to security protection, including at least: a personal information/confidential information management apparatus; a personal information/confidential information data sharing management server for storing personal information/confidential information in shares; and a database for managing personal information/confidential information, wherein: the personal information/confidential information management apparatus has a function of connecting the personal information/confidential information data sharing management server and the database for managing personal information/confidential information, and has a processing unit and a storage unit; a data attribute definition file defining a protection level of personal information/confidential information to be stored is stored in the storage unit; the data attribute definition file may include specified protection level and specified timing, which are referred to for a protection level change; and the processing unit determines a storage mode depending on the protection level referring to the data attribute definition file, stores the personal information/confidential information in at least one of the personal information/confidential information data sharing storage server and the database for managing the personal information/confidential information, and changes the storage mode depending on information for changing the protection level if the information for change the protection level is described in the data attribute definition file.

In the present invention, “personal information/confidential information” denotes information including content to be concealed as typified by personal information and confidential information. Therefore, it is not limited to personal information and confidential information in narrow definition. For example, when an individual or juridical person files a patent application, the patent application document may be “personal information/confidential information” until it is filed or laid-open.

The user can freely define the “protection level”. The levels A, B, and C in the embodiment are an example. Generally, the protection level of individual identifying information capable of identifying a person uniquely is high; the protection level of non-confidential information incapable of identifying a person uniquely is low; and semi-individual identifying information capable of identifying a person uniquely if a plurality thereof is referred to in combination has an intermediate protection level.

According to claim 2, in the personal information/confidential information management system according to claim 1, a plurality of levels are defined as protection levels from the highest to the lowest in accordance with the degree of security protection of information, and the protection level can be changed from a present level to another arbitrary level.

For example, provided that the protection levels are A, B, and C in descending order, if the present protection level is C, it can be changed to B or A, which are higher than the level C; and if the present protection level is A, it can be changed to B or C, which are lower than the level A.

According to claim 3, in the personal information/confidential information management system according to claim 1 or 2, the processing unit refers to the specified timing included in the information for changing the protection level; and automatically changes the data storage mode depending on the protection level at the specified timing.

Further, to achieve the object, a personal information/confidential information management method according to claim 4 is a personal information/confidential information management method using a computer for storing personal information/confidential information in a mode, which is different for each of the protection levels, depending on a protection level defined according to degree of secrecy of personal information/confidential information, including: acquiring personal information/confidential information, which is stored depending on a present protection level, with an input of information for changing the protection level, the information specifying at least a protection level and a timing; and storing the acquired personal information/confidential information in a mode depending on a specified new protection level.

### EFFECT OF THE INVENTION

According to the present invention, the protection level of personal information/confidential information is freely defined and changed by describing a data attribute definition file, and data can be suitably managed according to necessity of security protection at each occasion. Such flexible handling is possible only by changing the data attribute definition file as input information of a computer program without modifying the computer program. Further, the protection level can be changed both from low level to high level and from high level to low level, so that personal information/confidential information can be stored suitably.

### BEST MODE FOR CARRYING OUT THE INVENTION

FIG. 1 shows a system configuration of an embodiment.

A personal information/confidential information management apparatus 1 is connected to a user terminal 2 via communication means N1 such as the Internet. The user terminal 2 sends storage request with respect to personal information/confidential information or acquisition request with respect to stored information to the personal information/confidential information management apparatus 1. The user terminal 2 can also request the personal information/confidential information management apparatus 1 to change the protection level of the personal information/confidential information when needed.

The personal information/confidential information management apparatus 1 is also connected to a personal information/confidential information data splitting and storing server 3 (hereinbelow, “sharing management server 3”) via communication means N2. The sharing management server 3 has a plurality of storing media 4 for storing original data split in some parts. Here, the original data denotes personal information/confidential information to be stored.

The sharing management server 3 provides functions of splitting data, storing the split data, and reconstructing the original data based on information for reconstruction included in the split data (hereinbelow, referred to as “index key for decryption”).

As a method of splitting and storing data, the “secrete sharing scheme” is typical, but the method is not limited thereto.

When the sharing management server 3 receives a storage request from the personal information/confidential information management apparatus 1, it splits the original data by a predetermined method and stores the split data in the plurality of storing media 4. At this time, the sharing management server 3 generates an index key as information for reconstructing the split data. When the sharing management server 3 finishes splitting and storing the original data and generating the index key for decryption, it transmits the index key for decryption to the personal information/confidential information management apparatus 1.

Further, the personal information/confidential information management apparatus 1 can access a database 5 for managing personal information/confidential information (hereinbelow, referred to as “management DB 5”). The management DB 5 may be stored in a storage device built in the personal information/confidential information management apparatus 1, an external storage device, or a storing device in a database server, which is a computer separate from the personal information/confidential information management apparatus 1.

In the management DB 5, personal information/confidential information itself and a keyword for accessing the personal information/confidential information (hereinbelow, referred to as “search key”) are stored. As a search key, anything capable of identifying personal information/confidential information such as a file name or a file ID given to a file storing the personal information/confidential information may be used.

Personal information/confidential information is stored in an encrypted state or in plain text depending on the protection level in the management DB 5 in association with a search key. Further, for personal information/confidential information of high protection level, which is split and stored in the sharing management server 3, an index key for decryption is stored in association with a search key.

Subsequently, the personal information/confidential information management apparatus 1 will be described with reference to FIG. 2.

The personal information/confidential information management apparatus 1 has a storage unit 6 and a processing unit 7. The apparatus 1 also has, although not shown, input means such as a keyboard and a mouse, screen display means, and an interface for transmitting/receiving information to/from the user terminal 2 or the like via the communication means N1 and N2.

The storage 6 stores computer programs, data attribute definition files, and the like. The data attribute definition file will be described in detail later.

The processing unit 7 includes a data definition reading means 8, a data storing means 9, and a data acquiring means 10.

The data definition reading means 8 reads the protection level of subject personal information/confidential information referring to the data attribute definition file.

The data storing means 9 stores data in a storage mode according to a protection level notified from the data definition reading means 8.

The data acquiring means 10 acquires data according to the protection level notified from the data definition reading means 8.

The details of each of the means 8, 9, and 10 included in the processing unit 7 will be described later. The functions of the processing unit 7 are mainly realized by a CPU, which is not shown, executing a computer program stored in the storage unit 6. Here, a part of the functions may be realized by hardware.

The present invention is characterized in that, when the protection level of stored information is changed, the storage mode of the information is changed depending on the protection level.

Prior to detailed description of a change in the storage mode, storage of personal information/confidential information by the personal information/confidential information management apparatus 1 will be outlined.

When it becomes necessary to store data or acquire data so as to address a request from the user terminal 2, the data definition reading means 8 reads protection level of the data referring to a data attribute definition file 11 in which properties of subject personal information/confidential information data are described. According to the received result, the data storing means 9 stores data in both of the sharing management server 3 and the management DB 5 or in the management DB 5; and the data acquiring means 10 acquires data from both of the sharing management server 3 and the management DB 5 or from the management DB 5.

The protection level, which is important concept in the present invention, will be described in detail.

In the embodiment, three protection levels A, B, and C are defined. Personal information/confidential information at the protection level A requires cautious handling for a reason such that individual identifying information (for example, cellular phone number) capable of identifying an individual is included.

It is considered that technical data before filing a patent application or the like may be at level A. That is, the level A is a protection level given to information having extremely high necessity for protection.

The personal information/confidential information at the protection level B does not include the individual identifying information but includes semi-individual identifying information, that is, information which does not identify an individual by itself such as company name, sex, age, family structure, and the like. However, a specific individual may be indicated by a plurality of pieces of semi-individual identifying information. It is not necessary to store such information in the sharing management server 3 however it is risky to store such information in plain text. Consequently, such information is encrypted and stored in the management DB 5. The encryption key may be stored in a location different from the storage location of the personal information/confidential information in the management DB 5 or in another storage device.

It is considered that a patent application document, which has been already filed but not laid-open yet, or the like may be at level B. That is, the level B is a protection level given to information, which does not have extremely high necessity for protection but is refrained from being disclosed to the public.

Personal information/confidential information at the protection level C corresponds to information, which does not identify or indicate an individual singularly or plurally. In addition, it is considered that a patent application document, which has already been laid open, may be at level C. Such information does not have to be kept in confidential from the others, therefore it should not be a problem to store in the management DB 5 in plain text.

There is no absolute standard for determining the protection level of subject personal information/confidential information to be protection level A, B, or C and it may be determined depending on the subjective judgment of the owner of the information or the like.

The protection level of the personal information/confidential information is described in the data attribute definition file 11 stored in the storage unit 6. FIG. 3 shows an example. In each of records, the correspondence between a piece of information identifying data and its protection level is described. An example of information identifying data is a file name given to a file storing personal information/confidential information. In the data attribute definition file 11, a search key used to acquire the data from the sharing management server 3 or the management DB 5 such as storage time and user name, and a memo can be also described. An encrypting method and an encryption key may be also described in the data attribute definition file 11. Although the described content, a file format, a data structure, and the like may be various, the details thereof will not be described.

The data attribute definition file 11 may be transmitted together with a data storage request from the user terminal 2 to the personal information/confidential information management apparatus 1 and stored in the storage unit 6. Alternatively, the data attribute definition file 11 may be generated under a predetermined rule by the personal information/confidential information management apparatus 1 based on transmission/reception of information between the personal information/confidential information management apparatus 1 and the user terminal 2 using a Web page or the like. In this time, it is essential to make a protection level, which corresponds to a specific piece of personal information/confidential information, clearly available.

When a data storage request from the user terminal 2 is received, the protection level is read from the data attribute definition file 11 by the data definition reading means 8; and the data storing means 9, which is notified of the protection level, stores data depending on the protection level.

When the protection level is A, the data storing means 9 transmits the personal information/confidential information to the sharing management server 3 and acquires an index key for decryption from the sharing management server 3. The index key for decryption is stored in the management DB 5 in association with the search key for identifying the personal information/confidential information data.

When the protection level is B, the data storing means 9 encrypts the personal information/confidential information and stores the resultant information in the management DB 5 together with the search key.

When the protection level is C, the data storing means 9 stores the personal information/confidential information in plain text in the management DB 5 together with the search key.

As described above, the data storing means 9 transmits information to be stored to the sharing management server 3 and the management DB 5 or to the management DB 5 based on the data read by the data definition reading means 8 via the interface and the communication means.

Next, the process of the personal information/confidential information management apparatus 1 in the case where there is a data acquisition request is sent from the user terminal 2 will be outlined.

When the data acquisition request is received, the data definition reading means 8 reads the protection level of subject data referring to the data attribute definition file 11.

When the protection level is A, the data acquiring means 10 extracts the index key for decryption stored in association with the search key from the management DB 5, and transmits the index key for decryption to the sharing management server 3. The sharing management server 3 reconstructs data stored as a share on the basis of the received index key for decryption, and transmits the reconstructed data to the personal information/confidential information management apparatus 1.

When the protection level is B, the data acquiring means 10 acquires the encrypted personal information/confidential information from he management DB 5, decrypts the information with the encryption key stored separately, and then transmits to the user terminal 2.

When the protection level is C, the data acquiring means 10 acquires data in the plain text stored in association with the search key such as the file name from the management DB 5 and transmits the data to the user terminal 2.

The outline of storage and acquisition of personal information/confidential information depending on the protection level has been described above.

A change in the protection level will now be described hereinbelow.

In the embodiment, three protection levels A, B, and C are defined. Consequently, there are six change patterns as shown in FIG. 4.

A change in the protection level is described in the data attribute definition file 11.

For example, in FIG. 5, the protection level and the date are described in a pair. It can be seen from record (1) that personal information/confidential information data X is stored at the protection level A on Mar. 1, 2006; from record (2) that the data X is stored at the protection level B on Apr. 1, 2006, that is, storage mode of the data X should be changed from the previous protection level A to the protection level B on Apr. 1, 2006. Similarly, it can be seen from record (3) the data X should be stored while changing the protection level from B to C on Oct. 1, 2007.

To change the protection level described in the data attribute definition file 11, at least a specified level and a specified timing have to be included. The specified timing is year/month/day in the example of FIG. 5 but may include specified time. When specified time is not included, a default value may be set so as to perform a changing process at 12 AM on the specified date or the like.

The personal information/confidential information management apparatus 1 may preferably refer to the data attribute definition file 11 periodically, and automatically change the protection level on the specified year/month/day. Alternatively, by a batch process triggered by an operator via input means of the personal information/confidential information management apparatus 1, it may perform change process of the protection level changing. In any case, software mounted on the personal information/confidential information management apparatus 1 need not be changed by providing a file, in which a protection level change instruction is described.

The protection level changing process is a combination of: reading a data attribute definition file; acquiring stored data; and storing the data.

The data definition reading means 8 automatically refers to the data attribute definition file 11 as shown in FIG. 5 periodically. On Apr. 1, 2006, the data definition reading means 8 reads from the record (2) that the protection level of data X should be changed to B. The data definition reading means 8 refers to the data attribute definition file 11 as a whole so as to find the previous protection level of the data X is A and thus find that the protection level of the data X has to be changed from A to B on Apr. 1, 2006, and then notifies the data acquiring means 10 of the fact that the previous level of the data X is A.

The data acquiring means 10 refers to the management DB 5 and extracts the index key for decryption, which is associated with the search key of the data X. The data acquiring means 10 transmits the index key for decryption to the sharing management server 3 and requests to reconstruct data stored in shares and to transmit the reconstructed data.

When the data storing means 9 receives the reconstructed data X from the sharing management server 3, it encrypts the data X and stores the encrypted data X in association with the search key in the management DB 5 since the new protection level is B.

The process of changing the protection level of the data X from A to B is thus completed.

Similarly, on Oct. 1, 2007, the data definition reading means 8 reads from the records, (2) and (3) in FIG. 5 that the protection level of the data X should be changed from B to C.

The data definition reading means 8 notifies the data acquiring means 10 of the fact that the previous level of the data X is B. The data acquiring means 10 refers to the management DB 5 and extracts the encrypted data X.

Subsequently, since the new protection level of the data X is C, the data storing means 9 decrypts the data X and stores the data X in the plain text in the management DB 5 in association with the search key. The process of changing the protection level of the data X from B to C is thus completed.

In the case of lowering the protection level from A to C, it is sufficient to transmit the index key for decryption to the sharing management server 3 to request for transmission reconstructed data, and to store data received from the sharing management server 3 in plain text together with the search key in the management DB 5.

Next, a process performed in the case of raising the protection level will be described.

On May 1, 2006, the data definition reading means 8 reads from the records (4) and (5) that the protection level of data Y should be changed from C to B, and notifies the data acquiring means 10 of the fact that the previous level of the data Y is C.

The data acquiring means 10 refers to the management DB 5 and extracts the data Y. Here, the data Y is in the plain text.

Since the new protection level is E, the data storing means 9 encrypts the data Y in the plain text and then stores the encrypted data Y in association with the search key in the management DB 5.

The process of changing the protection level of the data Y from C to B is completed.

Similarly, on Jul. 1, 2006, the data definition reading means 8 reads from the records (5) and (6) that the protection level of data Y should be changed from B to A. The data definition reading means 8 notifies the data acquiring means 10 of the fact that the previous level of the data Y is B. The data acquiring means 10 refers to the management DB 5 and extracts the encrypted data Y.

Subsequently, the data storing means 9 decrypts the data Y and transmits it to the sharing management server 3. The sharing management server 3 stores the data in shares and transmits an index key for decryption to the data storing means 9. Then the data storing means 9 stores the index key for decryption in association with the search key in the management DB 5.

The process of changing the protection level of the data Y from B to A is thus completed.

In the case of raising the protection level from C to A, the data storing means 9 transmits subject data in the plain text acquired by the data acquiring means 10 to the sharing management server 3. The index key for decryption is transmitted from the sharing management server 3, and then the data storing means 9 stores the index key in the management DB in association with the search key.

The process of changing the protection level from C to A is thus completed.

In the foregoing embodiment, the user terminal 2 serves as a client; the personal information/confidential information management apparatus 1 serves as a server; and the server processes a request from the client. However, such configuration is just an example. The personal information/confidential information management apparatus may execute a process, which is instructed via its input means in stand-alone operation.

In the embodiment, three protection levels are used. However, the number of levels is just an example and the invention is not limited to the number. For example, a level which is intermediate between the levels A and B may be also provided. At this level, original data is split into some parts; some parts of the divided data are stored in the sharing management server, and the rest parts of the divided data are stored after encrypted or stored in plain text in the management DB 5.

The method of storing data depending on the protection level is not limited. For example, a storing method, in which a bit length is changed depending on the protection level and a strong encrypting method using a long bit length is used for data having the highest protection level, may be used. The points are that: data is appropriately stored depending on its protection level; the protection level can be suitably changed; the storage format is changed corresponding to the change of protection level.

Further, a change of an encryption key may be described in the data attribute definition file. The encryption key may be changed in real-time or in a batch process. The idea is similar to that of a change in the protection level. Specifically, it is sufficient: to provide a file, in which encryption key after a change and change timing are described in association with subject personal information/confidential information; and to make a computer program operating on the personal information/confidential information management apparatus 1 read the file.

In short, the embodiment disclosed as described above is illustrative and not restrictive. Therefore, various modifications are possible. The modifications are within the technical scope of the present invention as long as they are based on the technical idea of the present invention.

### INDUSTRIAL APPLICABILITY

The techniques of the present invention are used in industries, in which personal information/confidential information has to be handled in business or in which storage service for personal information/confidential information is provided in response to a request from a customer belonging to the above-described industries.

### BRIEF DESCRIPTION OF THE DRAWINGS

FIG. 1 is a diagram showing a system configuration of an embodiment.

FIG. 2 is a diagram showing functional blocks of a personal information/confidential information management apparatus of

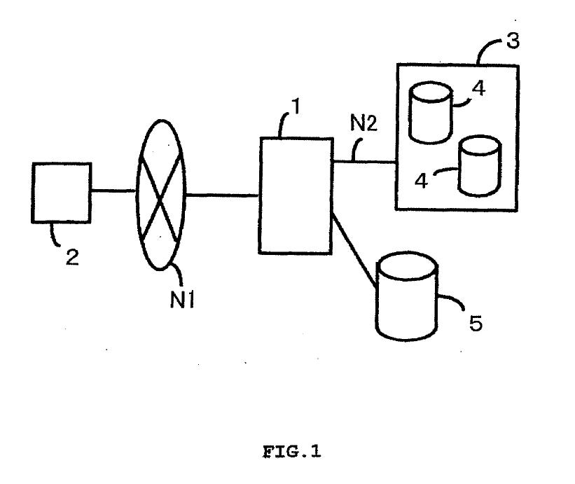

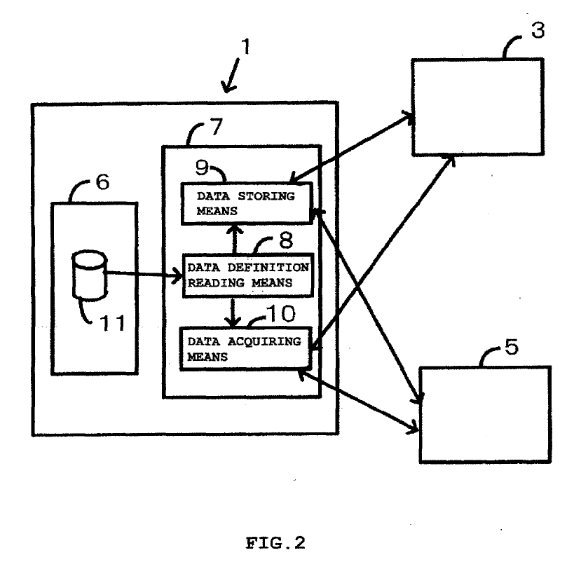

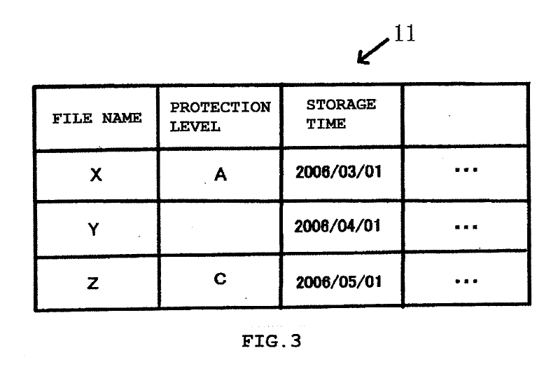

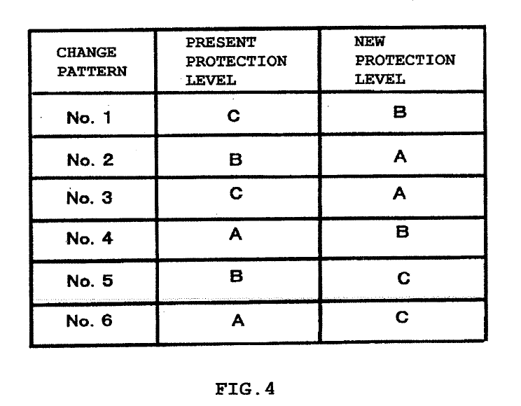

1. A personal information/confidential information management system for storing personal information/confidential information paying attention to security protection, comprising at least:
a personal information/confidential information management apparatus;
a personal information/confidential information data sharing management server for storing personal information/confidential information in shares; and
a database for managing personal information/confidential information wherein:
the personal information/confidential information management apparatus has a function of connecting the personal information/confidential information data sharing management server and the database for managing personal information/confidential information, and has a processing unit and a storage unit;
a data attribute definition file defining a protection level of personal information/confidential information to be stored is stored in the storage unit;
the data attribute definition file may include specified protection level and specified timing, which are referred to for a protection level change; and
the proceeding unit determines a storage mode depending on the protection level referring to the data attribute definition file, stores the personal information/confidential information in at least one of the personal information/confidential information data sharing storage server and the database for managing the personal information/confidential information, and changes the storage mode depending on information for changing the protection level if the information for changing the protection level is described in the data attribute definition file.

2. The personal information/confidential information management system according to claim 1, wherein a plurality of levels are defined as protection levels from the highest to the lowest in accordance with the degree of security protection of information, and the protection level can be changed from a present level to another arbitrary level.

3. The personal information/confidential information management system according to claim 1, wherein the processing unit refers to the specified timing included in the information for changing the protection level; and automatically changes the data storage mode depending on the protection level at the specified timing.

4. A personal information/confidential information management method using a computer for storing personal information/confidential information in a mode, which is different for each of the protection levels, depending on a protection level defined according to degree of secrecy of personal information/confidential information,
comprising:
acquiring personal information/confidential information, which is stored depending on a present protection level, with an input of information for changing the protection level, the information specifying at least a protection level and a timing; and
storing the acquired personal information/confidential information in a mode depending on a specified new protection level.

5. The personal information/confidential information management system according to claim 2, wherein the processing unit refers to the specified timing included in the information for changing the protection level; and automatically changes the data storage mode depending on the protection level at the specified timing.
